(19) United States
(12) Patent Application Publication
(10) Pub. No.: US 2010/0096533 A1
(43) Pub. Date: Apr. 22, 2010

(54) Fuel pump module snap-in support rod attachment

(75) Inventor: Patrick K. Powell, Farmington Hills, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/288,681

(22) Filed: Oct. 22, 2008

(51) Int. Cl. F16M 1/00

(52) U.S. Cl. 248/672

(57) ABSTRACT

A connection structure for a fuel pump module may employ a rod with a circumferential groove, and a flange with a vertical wall defining a longitudinal recession for installation of the rod. The entire length of the longitudinal recession may be exposed through a non-top and non-bottom side of the vertical wall. A boss protrudes from the vertical wall and the groove of the rod resides around the boss to prevent longitudinal motion of the rod. The vertical wall may further define a gap between two flat lands, which may be parallel. The distance between the lands is less than a diameter of the rod when the rod is installed within the recession. The vertical wall material defining the flat lands partially encloses and secures the rod within the longitudinal recession. The flat lands provoke an interference fit during rod installation but flex and bend permitting rod passage and installation.

### FIELD

The present disclosure relates to a support rod for a fuel pump module, and more particularly, to a snap-in support rod attachment for preventing three-dimensional movement of a support rod for a fuel pump module.

### BACKGROUND

The statements in this section merely provide background information related to the present disclosure and may not constitute prior art. Current fuel pump modules may employ two structures to connect a support rod to a fuel pump module flange. A first structure is a force fitting or interference fit of a rod end into a hole in the plastic flange of the fuel pump module. The hole is normally slightly smaller than the rod diameter at the rod end so that an initially tight interference fit is achieved between the rod and the plastic surrounding the hole. A disadvantage of the interference fit is that stresses are induced into the plastic surrounding the hole and such stresses remain in the plastic. The stress in the plastic material surrounding the hole may cause the plastic to eventually crack, for example, when subjected to by an outside force. The rod may also become loose in the hole due to vibration and movement caused by a vehicle riding upon various road surfaces.

A second structure may employ a general loose-fitting connection between the rod and the plastic surrounding a rod hole with the rod being secured longitudinally with a metal clip, such as an e-clip. However, a disadvantage is that while the support rod may remain within the confines of a hole in the bottom of the flange, such rod may not actually be attached to the flange, that is, the rod is only prevented from being removed from the flange by the clip, yet the rod may move about within the hole. That is, the rod may still move horizontally and vertically to some extent (i.e. in the X, Y and Z directions). Thus, stress in the plastic surrounding the hole may be reduced, yet the fit of the rod in the hole is not tight and noise, vibration and harshness may persist. Additionally, a fit between the rod and the plastic surrounding the hole that is not tight, is not advantageous.

What is needed then is a device that does not suffer from the above disadvantages. This, in turn, will provide a device, such as a flange, that does not have stress imparted to it from an interference fit of a support rod and the flange; furthermore, a fit will be provided between the rod and the flange such that no relative movement is permitted between the rod and the flange, such as in the horizontal directions or vertical direction.

### SUMMARY

A connection structure for a fuel pump module may include a rod and a fuel pump module flange. The flange may employ a top, largely horizontal plate, which may be flat on the top and bottom sides, or nearly flat, and a vertical side wall that protrudes downward from the plate. The vertical side wall may define a recession or hole open to the side, as opposed to the top or bottom, of the vertical side wall within which the rod may reside, after being passed through the periphery of the side wall. The vertical wall defining the recession may further define a boss, which may be a horizontal, semi-circular ring that protrudes from the rear of the wall forming the recession and toward a vertical centerline of the volume of the recession and into a groove or neck of the rod when the rod is in its installed position. When the groove of the rod is filled with the boss, longitudinal (up and down) motion of the rod is prevented. The groove of the rod is at a neck portion, which has a smaller rod diameter than adjacent rod lengths.

The boss defines a division in the recession between an upper recession and a lower recession, between which the neck of the rod resides. The vertical wall may further define a gap between two flexible arms forming a flexible clip, which may be integrally formed in the wall and secure around most of the rod with a “snap” sound when the rod is installed within the recession. The material of the flexible clip encompasses, covers or blocks enough of the rod to prevent the rod from coming out of the recession when the rod is installed in the recession. The perpendicular distance between ends of flexible clip arms of the flexible clip may be less than a diameter of the rod such that during installation of the rod into the recession, the rod will “snap” into place. That is, when fully and properly inserted, an audible “snap” may be heard while a distinctive feeling of the rod slipping or accelerating out of one's fingers and into the recession (from the parallel lands,) may also be felt as the rod lock, including opposing lands, resumes its resting or closed position, from its tensioned or opened position. The open position occurs with the rod positioned between the lands during rod installation. An end of the rod with the groove may reside within the recession while the majority of the rod does not reside within the recession. The fuel pump module flange may further employ a top plate and the top plate may contact a flat end of the rod when the rod is installed to prevent the rod from moving vertically. Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side view of a vehicle depicting a location of a vehicle fuel system;

FIG. 2 is a side view of a vehicle fuel system depicting a fuel pump module within the fuel tank;

FIG. 3 is a perspective view of a fuel tank depicting an aperture for installation of a fuel pump module;

FIG. 4 is a side view of a fuel pump module depicting representative locations of support rods;

FIG. 5 is an enlarged view of a fuel pump module flange and a support rod;

FIG. 6 is an enlarged view depicting a recess in the flange and the support rod for installation into the recess;

FIG. 7 is a side view of a support rod and a fuel pump module flange depicting the structure for securing the rod into the flange;

FIG. 8 is a side view of a support rod installed into a fuel pump module flange structure that secures the rod into the flange;

FIG. 9 is a top cross-sectional view depicting the flange recess and support rod prior to installation of the rod into the flange;

FIG. 10 is a top cross-sectional view depicting the flange recess and support rod at an intermediate step of installation of the rod into the flange; and

FIG. 11 is a top cross-sectional view depicting the flange recess and support rod after installation of the rod into the flange.

### DETAILED DESCRIPTION

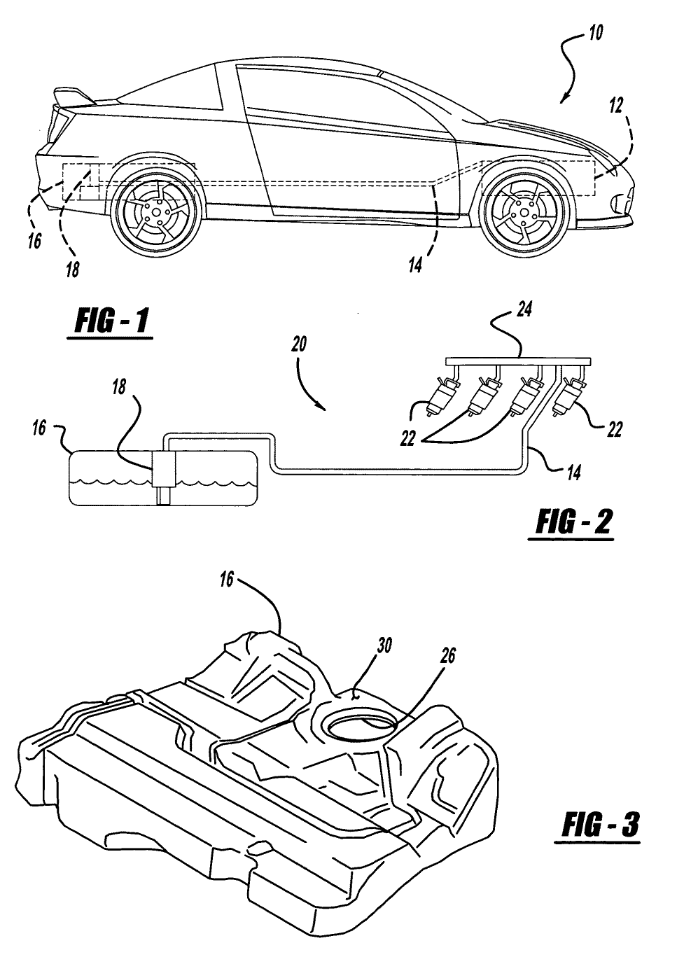

The following description is merely exemplary in nature and is not intended to limit the present disclosure, application, or uses. Throughout the drawings, corresponding reference numerals indicate like or corresponding parts and features. Turning now to FIGS. 1-8, features and details of the present teachings will be presented.

FIG. 1 depicts a vehicle 10, such as an automobile, having an engine 12, a fuel supply line 14, a fuel tank 16, and a fuel pump module 18. The fuel pump module 18 mounts within the fuel tank 16 with a flange and is normally submerged in or surrounded by varying amounts of liquid fuel within the fuel tank 16 when the fuel tank 16 possesses liquid fuel. A fuel pump within the fuel pump module 18 pumps fuel to the engine 12 through the fuel supply line 14.

FIG. 2 is a perspective view of a fuel supply system 20 depicting fuel injectors 22. In a returnless fuel system, only a fuel supply line 14 carries fuel between the fuel pump module 18 and a common fuel injector rail 24. Once the fuel reaches the injector rail 24, also called a “common rail,” as depicted in FIG. 2, the fuel passes into individual fuel injectors 22 before being sprayed or injected into individual combustion chambers of the internal combustion engine 12. The fuel supply system 20 depicted in FIG. 2 has no fuel return line from the injector rail 24 to the fuel tank 16. FIG. 3 is a perspective view of a vehicle fuel tank 16 depicting a mounting location 26, a hole, about which is a mounting surface 30 for a fuel pump module 18.

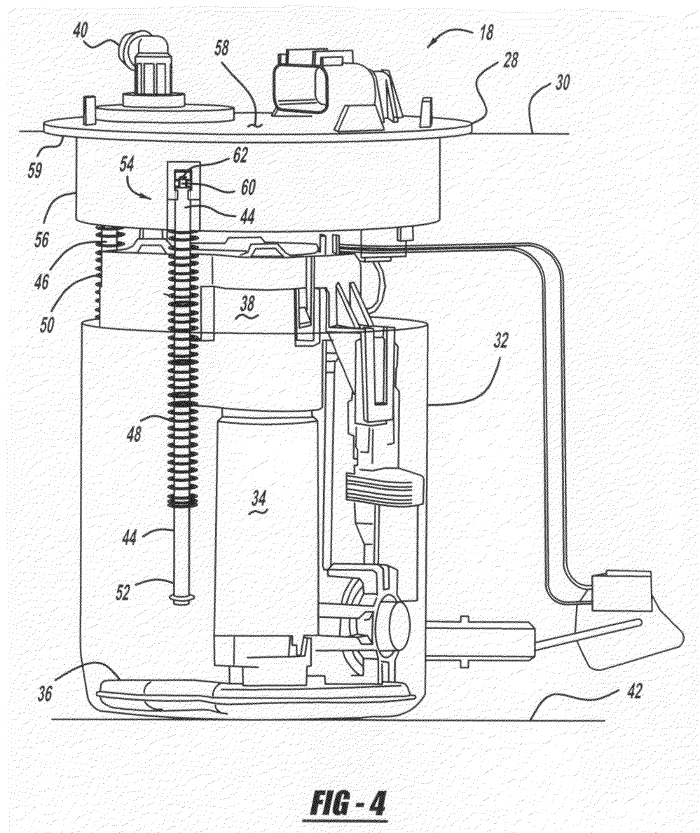

FIG. 4 depicts one embodiment of a fuel pump module 18 that may be lowered through the hole of the mounting location 26 on top of the fuel tank 16 when installed. More specifically, a fuel pump module flange 28 rests on the mounting surface 30 on the top of the fuel tank 16 when the fuel pump module 18 is in its installed position. Additionally, the fuel pump module 18 of FIG. 4 depicts a generally vertical cylindrical reservoir 32. Alternatively, the reservoir 32 may be oriented generally horizontally (not shown). An advantage of a horizontal reservoir is that less fuel tank depth is necessary to accommodate the reservoir. Alternatively, an advantage of a vertically oriented fuel pump module reservoir 32 is that less horizontal space is necessary for its installation and the reservoir itself may be firmly biased against the bottom interior of the fuel tank. That is, generally a vertical reservoir 32 may have a smaller overall diameter than a horizontal reservoir for the same vehicle application.

Continuing with reference to FIG. 4, the fuel pump module 18 includes at least one fuel pump 34 that draws fuel from the reservoir 32 and through a filter sock 36 and, in one example, through a fuel pump check valve 38 that may disposed at or near the top of the fuel pump 34. The fuel pump check valve 38 opens in response to positive pressure from within the fuel pump 34 to permit fuel to flow from the top of the fuel pump and into the fuel supply line 14 via fuel supply line port 40. To successfully pump fuel as generally described above, the fuel pump module 18 resides secured against the bottom interior surface 42 of the fuel tank 16. To maintain its secured position against the bottom interior surface 42 of the fuel tank 16, the fuel pump module 18 utilizes a first rod 44 and a second rod 46. More specifically, the first rod 44 may be surrounded by a first spring 48 and the second rod may be surrounded by a second spring 50. Because the rods 44, 46 function in the same manner, only the first rod 44 will be used to exemplify details of the disclosure.

Continuing with FIG. 4 and first rod 44, a first end 52 of the first rod 44 may be secured to the reservoir 32 in some fashion, such as by using a press fit into a portion of the reservoir 32, or by crimping the first end 52 or installing a washer at the first end 52 after passing it through part of the reservoir 32, such as a flange (not shown). A second end 54 of the first rod 44 may be firmly secured to the reservoir 32 at the flange 28 by a press or snap fit. More specifically, the second end 54 of the first rod 44 may pass through a vertical wall 56 that is perpendicular to a horizontal top 58 of the flange 28.

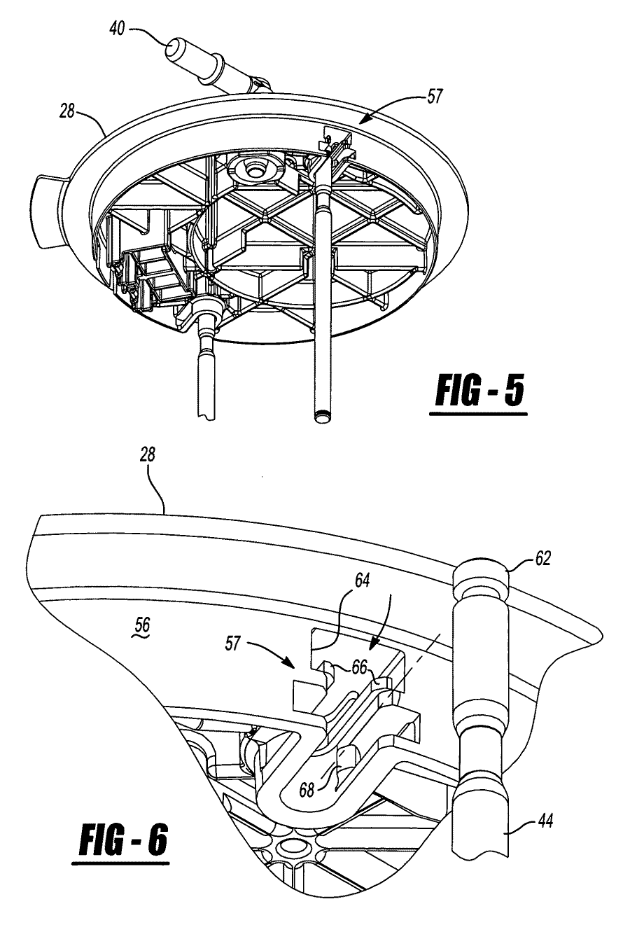

With continued reference to FIG. 4, and additional reference to FIGS. 5-8, further details of the first rod 44, flange 28, and the installation of the rod 44 into the flange 28 will be explained. FIG. 5 depicts a flange 28 with a rod lock 57, which is integrally molded into the flange 28, with the rod 44 installed. FIG. 6 depicts an enlargement of the rod lock 57 area of the flange 28. More specifically, the first rod 44 installs within the recess 64 of the flange 28 from the side of the flange 28. To securely hold the rod 44 in place, a variety of structures in the flange wall 56 are utilized. For instance, a stationary boss 66 and flexible clip 68 are, in part, used to secure the rod 44 in the recession. The flexible clip 68 snaps closed to secure the rod 44 into place.

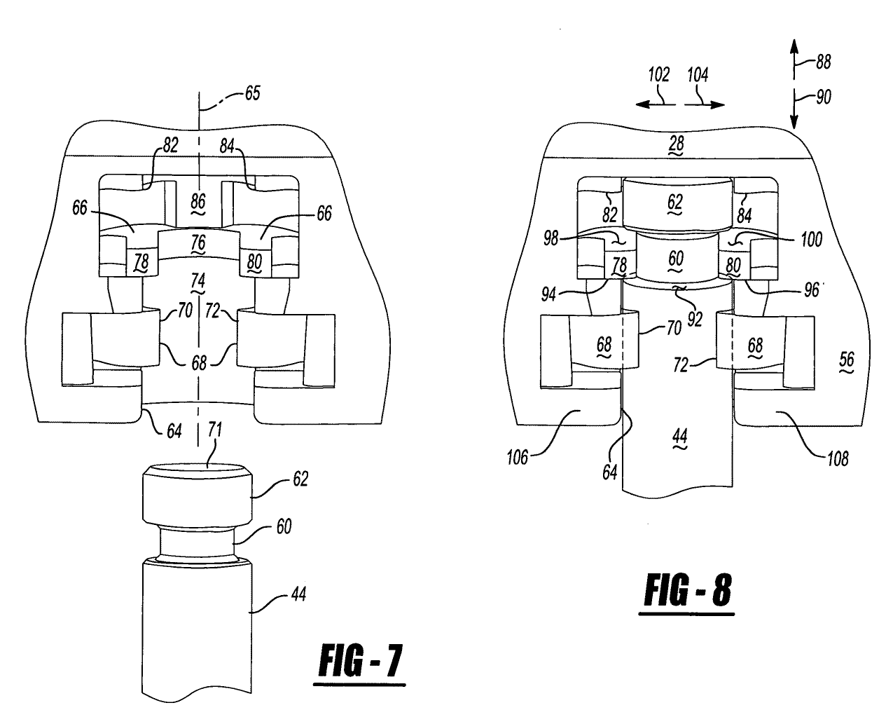

FIGS. 7 and 8 further depict the operative workings of the invention, and will now explained. FIG. 7 depicts the rod 44 with a rod tip 62 and a rod neck 60. Each part of the rod 44 fits into or is accommodated by parts within the recession 64 of the flange 28. Continuing, the recess contains a flexible clip 68 which may employ a first clip arm 70 and a second clip arm 72 that protrude into the recess such that a distance between the arms 70, 72 is less than the diameter of the rod 44 below the neck 60. The recess 64 of the flange 28 further defines a rear wall 74 and a collar 76. The protruding boss 66 has a first boss arm 78 and a second boss arm 80 that are part of the collar 76. Within the recess 64, the flange 28 also employs a first tip arm 82, second tip arm 84, and a rear tip rest 86, which together prevent motion of the rod tip 62 when the rod is installed in the recess 64. The neck 60 of the second end 54 of the first rod 44 may have a neck 60 that is smaller in diameter than the rod diameter on each side of the neck 60. As an example, the first rod 44 may be 6 mm in diameter from the first end 52 to the neck 60, which may be 3.5 mm, with the first rod 44 from the neck 60 to the tip 62 of the second end 54 again having a diameter of 6 mm. The decrease in diameter of the neck 60 in the rod may be in a non-tapered fashion and form 90 degree angles with the larger diameter portions of the rod on each side of the neck 60, such as with the tip 62 and the side of the neck 60 opposite to the tip 62.

Turning now to FIG. 8, a more detailed discussion of the features that prevent the rod 44 from moving upon installation into the recess 64 will be presented. FIG. 8 depicts the rod tip 62 situated at the top of the recess 64 between and in contact with the first tip arm 82 and the second tip arm 84. When in its installed position, the rod tip 62 contacts the rear tip rest 86. On the rod 44 and below the rod tip 62, is the rod neck 60, which is situated within a collar 76, or boss. The collar 76 or boss has a first boss arm 78 and a second boss arm 80 which lie on either side of the neck 60. The neck 60 may contact the first boss arm 78 and second boss arm 80 and the rear of the collar 76. Together, the collar 76 and the boss arms 78, 80 prevent the rod 44 from moving up and down, or vertically, in accordance with arrow 88 and arrow 90. Vertical movement is prevented because the tip 62 of the rod 44 contacts a top surface 98 of the first boss arm 78 and a top surface 100 of the second boss arm 80. The boss arms 78, 80 may contact the neck 60 and reside under the tip 62, as depicted in FIG. 8. In its installed position, the tip 62 may or may not be in contact with the boss arms 78, 80. If not in contact, the space between the bottom of the tip 62 is minimal, such approximately 1 mm. To prevent upward movement of the rod 44 in accordance with the arrow 88, the tip 62 may be positioned against the bottom of the flange 28. Similarly, the land 92 of the rod 44 may contact the bottom surface 94 of the first boss arm 78 or the bottom surface 96 of the second boss arm 80.

Continuing with FIG. 8, to prevent the rod 44 from moving side to side, or in accordance with arrow 102 and arrow 104, the rod tip 62 may be in contact with the first tip arm 82 and second tip arm 84. Alternatively, a small gap, such as less than 3 mm, may remain between the rod tip 62 and the first tip arm 82 and the second tip arm 84. Similarly, the boss arms 78, 80 may contact the neck 60 and prevent movement in accordance with arrows 102, 104. A small gap, such as less than three millimeters, may be present between the neck 60 and the first boss arm 78 and the second boss arm 80, to ease installation and removal of the rod 44.

Continuing with FIG. 8, at the bottom of the recess 64, the flange wall 56 forms a first guide or first post 106 and a second guide or second post 108. Each of the posts 106, 108 protrude toward a vertical centerline of the recess 64 and toward the rod 44 when the rod 44 is installed within the recess 64. A gap, such as less than three millimeters, may lie between the rod 44 and each of the posts 106, 108 to facilitate installation and removal of the rod 44 from the recess 64. The posts 106, 108 prevent movement of the rod 44 in accordance with the arrows 102, 104.

With reference again to FIG. 7, the recession 64 and the component parts that secure the rod 44 in place will be further described. The component parts that lie within or are part of the recess 64 are molded together with the flange 28 and its vertical wall 56. That is, the parts that secure the rod 44 into the flange 28 are integrally molded with the flange 28, and advantage of which is that no parts can become disassembled from the flange 28, rattle, or otherwise permit the rod 44 to move within the recess 64. Therefore, the first and second trip arms 82, 84, the rear tip rest 86, the boss 66 and its collar 76, the boss arms 78, 80, the rear wall 74 and the first and second arms 70, 72, which act as in concert as a flexible clip 68 are integrally molded as part of the flange 28.

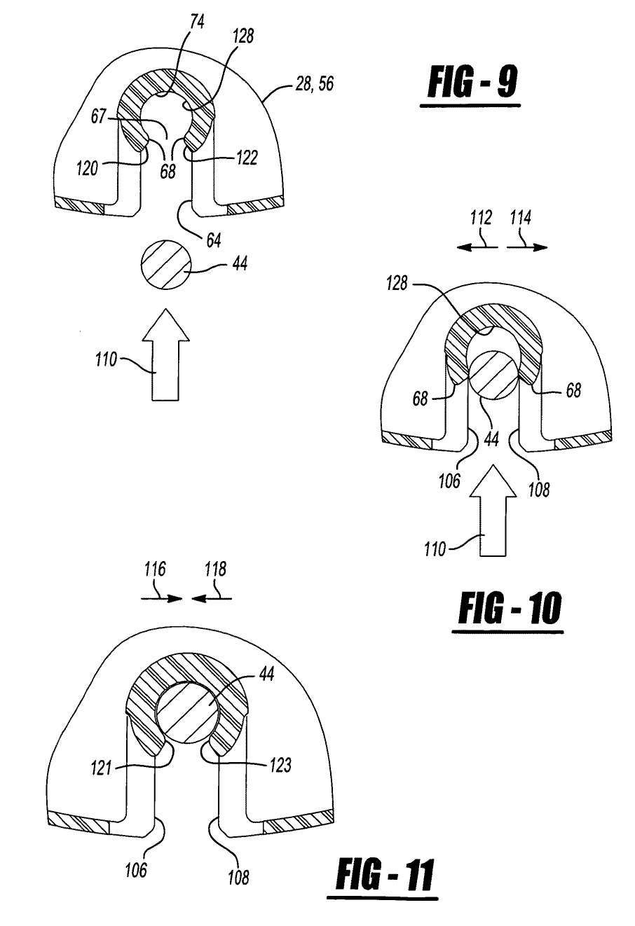

Turning now to FIGS. 9-11, a more detailed description of insertion of the rod 44 into the recession 64 of the flange 28 will be described. FIGS. 9-11 depict a cross-sectional top view through the flexible clip 68 to depict how the flexible clip 68 accepts and grips the rod 44. FIG. 9 depicts the rod 44 spaced away from the recession 64. To insert the rod 44 into the flange 28, the rod 44 may be translated in accordance with arrow 110 toward the rear wall 74, and between the first boss arm 78 and second boss arm 80 that together make up the flexible clip 68. Continuing with FIG. 10, as the rod 44 is moved toward the flexible clip 68, the rod 44 eventually contacts the first clip arm 70 and the second clip arm 72. Upon contact of the rod 44 with the arms 70, 72, the arms 70, 72 will begin to flex outwardly, or away from the moving rod 44, in accordance with arrow 112 and arrow 114. As the rod 44 is inserted into the recess 64, the rod 44 may contact the first post 106 and the second post 108, which together may act as a guide. Turning now to FIG. 11, upon the rod 44 approaching full insertion into the flexible clip 68, the first clip arm 70 will move in accordance with arrow 116 and the second clip arm 72 will move in accordance with arrow 118, or toward each other and further engulfing or encapsulating the rod 44. Since the rod 44 depicted in FIG. 11 is in its fully installed position, the flexible clip 68 is in its relaxed, or non-stressed state, as the flexible clip 68 is in FIG. 9, before installation of the rod 44. As depicted in FIGS. 9 and 11, the shortest distance between the first clip arm 70 and second clip arm 72 is less than the cross-sectional diameter of the rod 44. Because the flexible clip 68 must be forced open, that is, in accordance with arrows 112, 114, to either insert or remove the rod 44, the rod 44 is securely held in place when it is installed and within the confines of the flexible clip 68, as depicted in FIG. 11 and FIG. 8.

With reference again to FIG. 9, although also evident in FIGS. 10-11, the flexible clip 68 has a land 120 and 122, on the first clip arm 70 and the second clip arm 72, respectively. The lands 120, 122 may be a flat or relatively flat surface and form part of the tips 124, 126 of each of the arms 70, 72. Alternatively, the lands 120, 122 may be slightly rounded or crowned. As depicted in FIGS. 9-11, the lands 120, 122 are angled relative to each other such that the largest distance between the lands is at the point on the lands farthest from the receptacle 128, and the shortest distance between the lands 120, 122 is at the point on the lands closest to the receptacle 128. The arrangement of the lands 120, 122 of the flexible clip 68 facilitates installation of the rod 44 into the receptacle 128 in accordance with arrow 110. While insertion of the rod 44 into the receptacle 128 is eased with the arrangement of the lands 120, 122, removal of the rod 44 from the receptacle 128 may be more difficult than insertion. To facilitate installation of the first rod 44 into the recess 64, the land 120 may have a radiused corner 121 while the land 122 may have a radiused corner 123.

An advantage of using the flexible clip 68 for insertion of the rod 44 into the receptacle 128 is that the flexible clip 68 provides positive tactile feedback to a person who is installing the rod 44, even if the installer is not looking at the receptacle 128 and flexible clip 68. More specifically, when the rod 44 is pressed onto and contacts the lands 120, 122, an installer will begin to feel resistance as the flexible clip 68 provides resistance, which increases as the tips 124 and 126 of the flexible clip 68 open in accordance with the arrows 112 and 114, respectively. The resistance increases because the flexible clip 68 acts as a spring and biases against the force that is used to open the flexible clip 68. As long as the flexible clip 68 is being spread open, the resistance will increase; however, upon the diameter of the rod 44 passing the shortest distance between the lands 120, 122, the tips 124, 126 of the flexible clip 68 will begin to close, or come together. As the flexible clip 68 begins and continues to close, as the rod 44 continues its progress toward the rear wall 74, the resistance becomes less and less until the rod 44 is fully inserted into the receptacle, at which point the resistance becomes zero. Because an installer feels the increase and decrease in resistance, one may install the rod with confidence, knowing the installation is proper, even without looking at the flexible clip 68 and receptacle 128. Furthermore, when the rod 44 is installed in one consistent speed, a snapping or popping noise may be heard. The snapping or popping noise may be the noise of the rod 44 striking the rear wall 74 of the receptacle 128.

Therefore, the teachings of the present disclosure include a connection structure for a fuel pump module 18. More specifically, the connection structure may include a rod 44 and a flange 28. The flange 28 may define a top horizontal plate 58, which may be flat on the top and bottom sides, and a vertical wall 56. The vertical wall 56 may define a longitudinal recession 64 or hole open to a side 56, such as a horizontal side, as opposed to the top side or bottom side. The rod 44 may be translated from the side of the flange and into the vertical recession. The vertical wall 56 defining the recession 64 may further define a boss 66, which may protrude horizontally toward a vertical centerline 65 of the recession 64 and into the neck 60 of the rod 44 when the rod 44 is in its installed position. The boss 66 prevents longitudinal, that is, up and down, motion of the rod 44. The neck 60 portion is smaller in diameter than adjacent non-neck rod 44 lengths. The boss 66 demarks or marks a division in the recession 64 between an upper recession 64 and a lower recession 64, between which the neck 60 of the rod 44 resides. The vertical wall 56 may further define a gap between a first clip arm end and a second clip arm end, together which secure the rod 44 when installed within the recession 64. The gap is less than a diameter of the rod 44. During installation of the rod 44 into the recession 64, the rod 44 will “snap” into place when the flexible clip 68 contacts and travels around the rod 44. That is, when fully and properly inserted, an audible “snap” may be heard from the flexible clip 68 while a distinctive feeling of the rod 44 slipping or accelerating out of one's fingers and into the recession 64, from the first clip arm 70 and the second clip arm 72, may also be felt as the flexible clip 68 resumes its resting or closed position, from its tensioned or opened position. The closed position of the flexible clip 68 is depicted in FIGS. 7, 8, 9 and 11. The open position occurs when the rod 44 is positioned between the ends of the flexible clip 68, as in FIG. 10.

In another example, a connection structure for a fuel pump module may employ a rod 44 and a flange 28 defining a top horizontal plate and a vertical wall 56. The vertical wall 56 may define a recession 64 open to a non-top and non-bottom side of the vertical wall 56 within which the rod resides. The recession 64 is open in a horizontal direction from the side of the vertical wall 56. The vertical wall defining the recession may further employ a boss 66 that protrudes toward a vertical centerline 65 of a volume of the recession 64 and into a groove or neck 60 of the rod 44. The boss prevents longitudinal motion, or motion in accordance with arrows 88, 90, of the rod 44. The boss 66 may be a horizontal, semi-circular ring and employ a first boss arm 78 and a second boss arm 80. The recession of the vertical wall 56 may further employ a first protruding boss arm 78 and a second protruding boss arm 80 while the rod 44 may further employ a neck 60 having a diameter smaller than adjacent rod lengths, the neck area 60 of the rod 44 may reside between the first protruding boss arm 78 and the second protruding boss arm 80.

In another example of the above disclosure, a connection structure for attaching a rod to a fuel pump module flange 28 may employ a rod 44 defining a circular groove 60 or neck 60 about the rod circumference while a vertical wall 56 of the flange 28 may define a longitudinal recession 64 open to a horizontal side, as opposed to a top side or a bottom side, of the vertical wall 56 to provide access to the recession 64 through the vertical wall 56. The rod 44 may reside within the recession 64. More specifically, a boss 66 within the recession 64 may protrude toward a vertical centerline 65 of a volume of the recession 64 and around the neck 60 of the rod 44. The boss 66 may be a semi-circular ring and prevent longitudinal motion, such as in accordance with the arrows 88, 90, of the rod 44. The connection structure of the flange 28 may further employ a top plate that may contact a flat end of the rod 44 to prevent the rod 44 from moving vertically. Still yet, a flexible clip 68 may define a first clip arm 70 with a first clip arm end and a second clip arm 72 with a second clip arm end and defining a gap 67 between the first clip arm end and the second clip arm end. A distance between the first clip arm end and the second clip arm end is less than the diameter of the rod on either side of the neck 60. The first clip arm end and the second clip arm end are capable of biasing to enlarge the gap 67 to a distance large enough to permit the rod 44 to pass between the first clip arm end and the second clip arm end, as depicted in FIG. 10.

In yet another example of a connection structure for attaching a rod 44 to a fuel pump module flange 28, the connection structure may employ a rod 44 defining a first rod diameter and a neck 60 defining a second, smaller rod diameter. Additionally, a horizontal flange top may be adjoined to a vertical flange wall 56, which may define a longitudinal (up and down in accordance with arrows 88, 90) recession 64. The rod 44 may reside within the longitudinal recession 64 of the vertical wall. Moreover, the structure may employ a boss 66 with a first boss arm 78 and a second boss arm 80. The boss 66 may demark a division in the longitudinal recession 64 and define an upper recession and a lower recession. The neck 60 of the rod 44 may reside within the boss 66, between the first boss arm 78 and the second boss arm 80. Still yet, the structure may employ a flexible clip 68 defining a first clip arm 70 with a first clip arm end and a second clip arm 72 with a second clip arm end, and define a gap 67 between the first clip arm end and the second clip arm end. A distance between the first clip arm end and the second clip arm end is less than the first rod diameter. An entire length of the longitudinal recession 64 may be exposed through a non-top and non-bottom side of the vertical wall 56. The connection structure may further employ a top plate of the flange 28 and a flat rod end 71 proximate the neck 60 of the rod 44. The flat rod end 71 may contact a bottom surface of the flange 28 to prevent longitudinal motion of the rod 44 when the rod 44 is installed in the longitudinal recession 64.

Continuing, the rod may employ a rod tip 62 while the recession 64 of the vertical wall 56 may further employ a first tip arm 82 and a second tip arm 84. The first tip arm 82 may reside on a first side of the rod tip 62 and the second tip arm 84 may reside on a second side of the rod tip 62. With reference to FIGS. 9-11, the first clip arm 70 may further define a first flat land and the second clip arm 72 may further define a second flat land, the first and second flat lands may contact the rod 44 during installation of the rod 44 in the flexible clip 68. The first clip arm 70 and the second clip arm 72 of the flexible clip 68 may bias to enlarge the gap 67 between the first clip arm end and the second clip arm end. The flange 28, including the horizontal flange top, the first boss arm 78, the second boss arm 80, the first clip arm 70, the second clip arm 72, the first tip arm 82, and the second tip arm 84 may be integrally molded as one piece of material within the vertical recession. One advantage of being an integral piece is that assembly and movement between separate parts is eliminated.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A connection structure for a fuel pump module comprising:
a rod; and
a flange defining a top horizontal plate and a vertical wall, the vertical wall defining a recession open to a non-top and non-bottom side of the vertical wall within which the rod resides.

2. The connection structure of claim 1, the vertical wall defining the recession further comprising:
a boss that protrudes toward a vertical centerline of a volume of the recession and into a groove of the rod.

3. The connection structure of claim 2, wherein the boss prevents longitudinal motion of the rod.

4. The connection structure of claim 2, wherein the boss is a horizontal, semi-circular ring.

5. The connection structure of claim 2, the recession of the vertical wall further comprising:
a first protruding boss arm; and
a second protruding boss arm;
the rod further defining:
a neck area having a diameter smaller than adjacent rod lengths, the neck area of the rod residing between the first protruding boss arm and the second protruding boss arm.

6. A connection structure for attaching a rod to a fuel pump module flange, the connection structure comprising:
a rod defining a circular groove about the rod circumference;
a vertical wall of the flange, the vertical wall defining a longitudinal recession open to a side of the vertical wall to provide access to the recession through the vertical wall, an end of the rod residing within the recession; and
a boss within the recession that protrudes toward a vertical centerline of a volume of the recession and around the circular groove of the rod.

7. The connection structure of claim 6, wherein the boss is a semi-circular ring and prevents longitudinal motion of the rod.

8. The connection structure of claim 7, the flange further comprising:
a top plate, the top plate contacting a flat end of the rod to prevent the rod from moving vertically.

9. The connection structure of claim 8, further comprising:
a flexible clip defining a first clip arm with a first clip arm end and a second clip arm with a second clip arm end and defining a gap between the first clip arm end and the second clip arm end, wherein a distance between the first clip arm end and the second clip arm end is less than a diameter of the rod.

10. The connection structure of claim 9, wherein the first clip arm end and the second clip arm end are capable of biasing to enlarge the gap to a distance large enough to permit the rod to pass between the first clip arm end and the second clip arm end.

11. A connection structure for attaching a rod to a fuel pump module flange, the connection structure comprising:
a rod defining a first rod diameter and a neck defining a second, smaller, rod diameter;
a horizontal flange top that adjoins a vertical flange wall, the vertical wall defining a longitudinal recession, the rod residing within the longitudinal recession, the vertical wall, within the recession, further comprising:
a boss comprising a first boss arm and a second boss arm, the boss demarking a division in the longitudinal recession and defining an upper recession and a lower recession, the neck of the rod residing within the boss, between the first boss arm and the second boss arm; and
a flexible clip defining a first clip arm with a first clip arm end and a second clip arm with a second clip arm end, and defining a gap between the first clip arm end and the second clip arm end, wherein a distance between the first clip arm end and the second clip arm end is less than the first rod diameter.

12. The connection structure of claim 11, wherein an entire length of the longitudinal recession is exposed through a non-top and non-bottom side of the vertical wall.

13. The connection structure of claim 12, further comprising:
a flange top plate; and
a flat rod end proximate the neck of the rod, the flat rod end contacting a bottom surface of the flange to prevent longitudinal motion of the rod when the rod is installed in the longitudinal recession.

14. The connection structure of claim 13, the rod further comprising:
a rod tip;
the recession of the vertical wall further defining:
a first tip arm; and
a second tip arm, the first tip arm residing on a first side of the rod tip and the second tip arm residing on a second side of the rod tip.

15. The connection structure of claim 14, wherein the first clip arm further defines a first flat land and the second clip arm further defines a second flat land, the first and second flat lands for contacting the rod during installation of the rod in the flexible clip.

16. The connection structure of claim 15, wherein the horizontal flange top, the first boss arm, the second boss arm, the first clip arm, the second clip arm, the first tip arm, and the second tip arm are integrally molded as one piece of material within the vertical recession.

17. The connection structure of claim 16, wherein the first clip arm and the second clip arm of the flexible clip bias to enlarge the gap between the first clip arm end and the second clip arm end.
